(19) United States
(12) Patent Application Publication
(10) Pub. No.: US 2017/0071710 A1
(43) Pub. Date: Mar. 16, 2017

(54) ROOT CANAL IRRIGATION NEEDLE ENHANCEMENT

(71) Applicant: Arnaud Deturmeny, Paris (FR)

(72) Inventor: Arnaud Deturmeny, Paris (FR)

(21) Appl. No.: 15/125,290

(22) PCT Filed: Mar. 11, 2015
(86) PCT No.: PCT/FR2015/050609

§ 371 Date: Sep. 12, 2016

(30) Foreign Application Priority Data
Mar. 11, 2014 (FR) 1452003

(51) Int. Cl. A61C 17/02; A61C 5/02

(52) U.S. Cl. CPC A61C 17/02; A61C 5/02

(57) ABSTRACT

A root canal irrigation needle assembly used in the field of dental surgery and intended to be connected to an injection syringe includes a pipette and a connection sleeve.

### RELATED APPLICATIONS

This is the national stage, under 35 USC 371, of PCT application PCT/FR2015/050609, filed on Mar. 11, 2015, which claims the benefit of the Mar. 11, 2014 priority date of French Application 1452003, the content of which is herein incorporated by reference.

### FIELD OF INVENTION

The present invention relates to an enhancement to a root canal irrigation needle used in the field of dental surgery, more particularly intended for the dental treatment of root canals and for their irrigation in endodontics.

### BACKGROUND

The role of irrigation is to facilitate and supplement the mechanical action of the root canal instruments.

The irrigation of the endodontic system throughout the course of treatment is performed using a disinfecting solution. The solution used is generally 1% to 6% sodium hypochlorite and is injected using an irrigation needle connected to a syringe containing the solution. The irrigation also brings the debris into suspension, making it easier to eliminate said debris, so as to perfect the cleaning of the endodontic system.

The irrigation equipment is therefore composed of a needle connected to a syringe containing the irrigation solution. The connection to the syringe is effected by a traditional connector that is well known per se (Luer lock).

The current needles are of two types:

1) Metallic, cylindrical and of variable length and fineness (23 Ga to 32 Ga), their end being either straight, beveled or with one or more lateral outlets.

2) Made of plastic, straight or curved, they nonetheless have a large enough diameter for reaching the apical third.

As studies have shown, the part of the root canal that is the most difficult to clean remains the apical third, in particular the last 3 millimeters, which a traditional irrigation needle made of metal cannot access most of the time, either because of the fineness and/or curvature of the root canal or because of other anatomical complexities.

The many commercial attempts at an irrigation needle have been unable to offer a plastic needle that is sufficiently fine and rigid, or a metal needle that is sufficiently flexible, even using a nickel-titanium alloy (NiTi Stropko), to allow access to the final millimeters of the apex.

A recent model (Flexi from Vista) in 2 parts, with a fine cylindrical tube made of flexible woven rubber glued to a short metal needle, proves neither rigid enough nor strong enough.

### SUMMARY OF INVENTION

To improve the irrigation of the apical third, a very fine and conical needle made of flexible but sufficiently rigid plastic permits rapid access to the final millimeters of the apex, generally even before the shaping of the root canal has been completed, and it does this irrespective of the anatomical configuration of the root canal, while at the same time maintaining an excellent flow rate of the irrigation solution.

Thus, the root canal irrigation needle according to the invention used in the field of dental surgery is intended to be connected to an injection syringe and is characterized in that said needle is composed of an assembly comprising the needle itself, to be called a pipette, and a connection sleeve.

According to a complementary feature, the pipette is composed of a tubular profile with, at its center, a central conduit through which the root canal irrigation solution is injected, while the connection sleeve is intended to retain the pipette and permit connection to the syringe containing the irrigation solution.

According to another complementary feature, the connection sleeve comprises a tubular end part which is intended to retain the pipette and which is continued by a widened part that is itself also tubular.

Furthermore, the tubular end part retaining the pipette is composed of two segments, namely an end segment, and an intermediate segment connecting the end segment to the base of the connection sleeve, while the end segment forms an obtuse angle with the intermediate segment, such that the axis of the injection end of the pipette is not in the continuation of the axis of the syringe.

The pipette is composed of a tubular profile with, at its center, a central conduit through which the root canal irrigation solution is injected, while it extends from its injection end to the inside of the connection sleeve, advantageously as far as the end edge, or even beyond this edge, so as to protrude beyond this edge.

It will be noted that the pipette is of conical shape so as to terminate in a point and through an injection orifice of small diameter, in order to easily access the final millimeters of the apex.

It will also be noted that the end edge comprises two lateral diametric connection projections intended to permit connection of the sleeve to the syringe, the connection being of the “Luer lock” type, for example.

According to the preferred embodiment, the pipette and the sleeve are made of plastic, for example polyvinyl chloride, in order to be flexible but sufficiently rigid and resistant to the mechanical stresses and to the corrosive action of the irrigating solution.

It will be noted that the sleeve is made of a more rigid material than the pipette, for example nylon.

Other features and advantages of the invention will become clear from the following description in which reference is made to the attached drawings, which are given only as non-limiting examples.

### BRIEF DESCRIPTION OF THE DRAWINGS

FIG. 1 is an external side view of the needle of the invention.

FIG. 1a is a sectional view along A-A.

FIG. 1b is an end view.

FIG. 1c is a sectional view along B-B.

FIG. 2 is a longitudinal sectional view.

FIG. 3 is an external side view before the needle is fitted on the injection syringe.

FIG. 4 is a side view of the assembly composed of needle and injection syringe.

FIG. 5 is a perspective view of the needle.

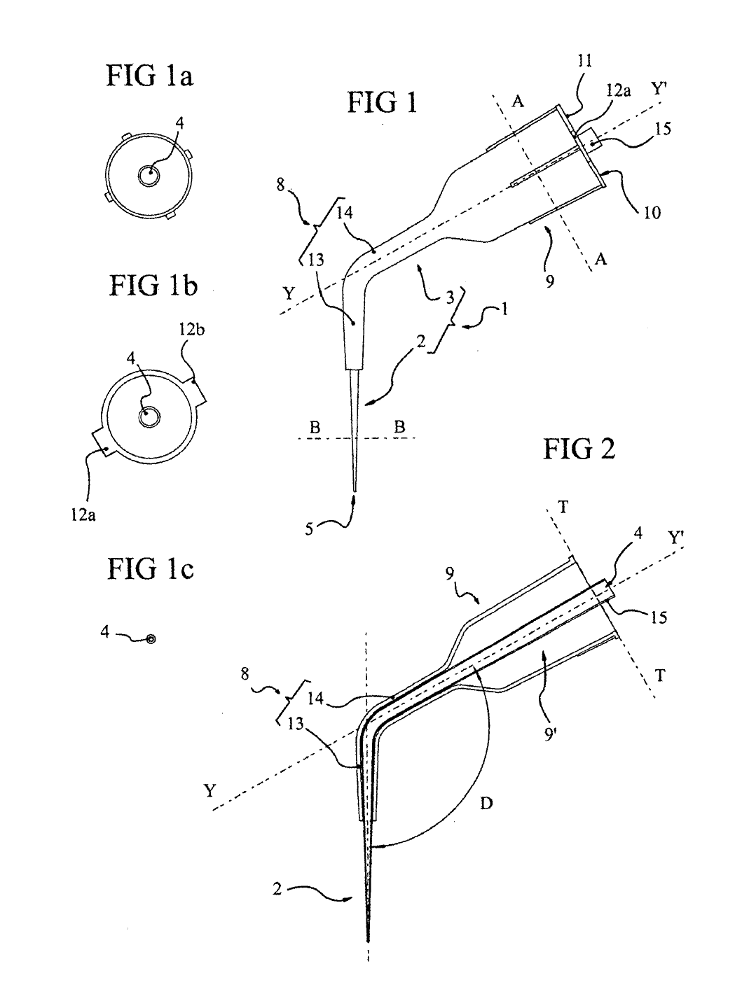

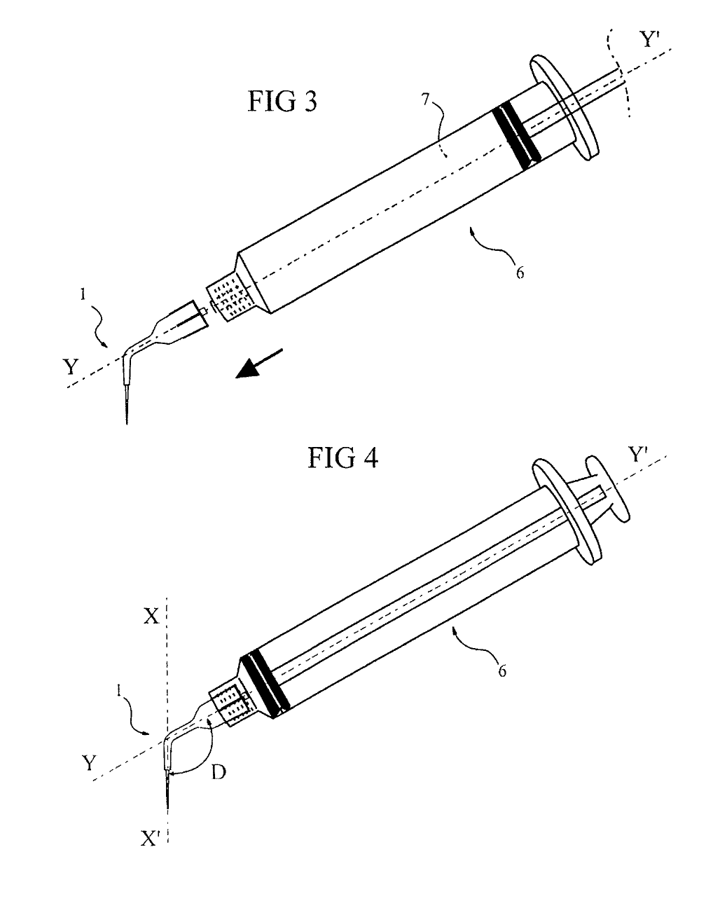

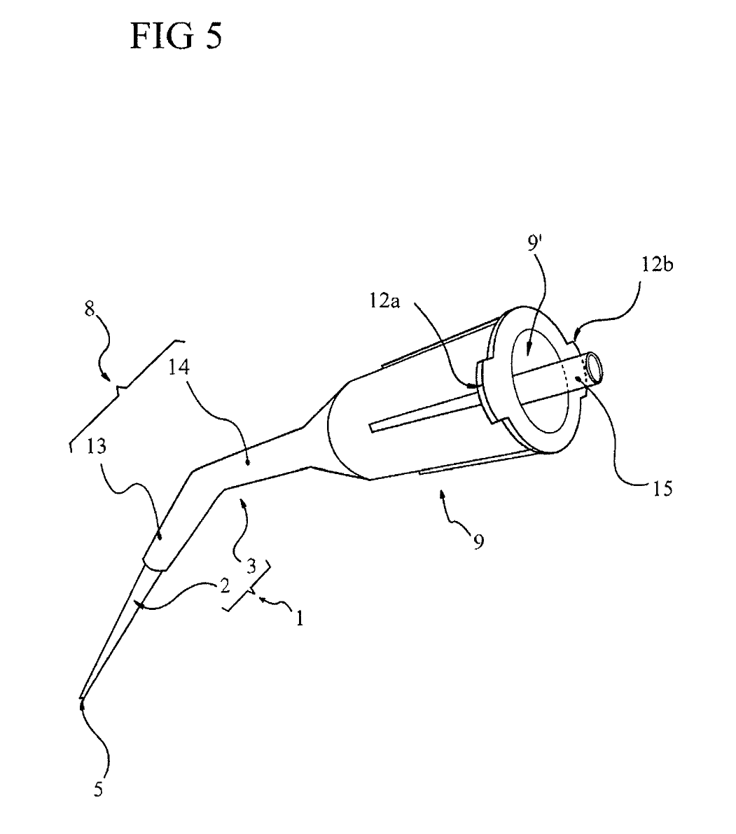

### DETAILED DESCRIPTION

The needle of the invention (1) is composed of two parts comprising the needle (2) itself, to be called a pipette, and a connection sleeve (3).

The pipette (2) is composed of a tubular profile with, at its center, a central conduit (4) through which the root canal irrigation solution is injected. Said pipette (2) is of conical shape so as to terminate in a point and through an injection orifice (5) of small diameter (0.25 mm to 0.30 mm), in order to ensure a substantial flow rate and easy access to the apical third. The pipette is made of plastic, for example PVC (polyvinyl chloride). Thus, the end of the pipette is advantageously flexible while maintaining a certain rigidity.

The connection sleeve (3) is intended to retain the pipette (2) and permit connection to the syringe (6) containing the irrigation solution (7). Thus, the connection sleeve (3) comprises a tubular conical end part (8) which is intended to retain the pipette (2) (with engagement by what is called a “Morse taper”) and which is continued by a widened part (9) that is itself also tubular, of which the end edge (10) comprises a flange (11) and lateral diametric connection projections (12a-12b) intended to permit connection of the sleeve to the syringe. The connection is of the “Luer lock” type, for example, a connection that is well known by this name in the medical field.

It will be noted that the tubular end part (8) retaining the pipette (2) is composed of two segments, namely an end segment (13), and an intermediate segment (14) connecting the end segment (13) to the widened part (9).

It will be noted that the end segment (13) forms an obtuse angle (D) with the intermediate segment (14). Thus, the axis (X, X′) of the injection end (20) of the pipette (2) is not in the continuation of the axis (Y, Y′) of the syringe (6), and instead it forms an angle of approximately 120° therewith.

The connection sleeve (3) is advantageously made of plastic such as nylon or another plastic injectable in a mold.

The pipette (2) protrudes from the connection end of the sleeve (13) by 17 mm to 21 mm.

It will be noted that the connection end (15) of the pipette (2) protrudes slightly with respect to the plane (T) of the end edge (10) in order to enter the end of the syringe.

It has been found that the orientation of the end of the pipette with respect to the axis of the syringe (approximately 120°) allows the surgeon to perform the injection into the root canal with much greater comfort. However, a straight model may serve for another type of irrigation syringe.

It has also been found that the tubular pipette (2) extends from its injection end to the inside (9′) of the connection sleeve (3), as can be seen more particularly in FIG. 2. Moreover, the pipette advantageously extends as far as the end edge (10), or even beyond this edge, as illustrated, such that the pipette can correctly convey the injection solution when the needle is connected to the corresponding syringe.

According to the embodiment proposed and illustrated, the assembly (1) is a combination of two independent parts (3) and (2), although it could be otherwise. Thus, the assembly (1) of pipette (2) and sleeve (3) could be produced in just one piece.

Of course, the invention is not limited to the embodiments that have been described and that are shown as examples, and instead it also includes all the technical equivalents and the combinations thereof.

1-12. (canceled)

13. An apparatus comprising a root-canal irrigation-needle assembly used in dental surgery, said assembly being configured to be connected to an injection syringe, wherein said needle assembly comprises a pipette and a connection sleeve.

14. The apparatus of claim 13, wherein said pipette comprises a tubular profile having, at a center thereof, a central conduit through which a root canal irrigation solution is injected, wherein said connection sleeve is configured to retain said pipette and to permit connection to said syringe containing said irrigation solution.

15. The apparatus of claim 13, wherein said connection sleeve comprises a tubular end part configured to retain said pipette, said tubular end part having a continuation that comprises a widened part that is also tubular.

16. The apparatus of claim 15, wherein said tubular end part retaining said pipette comprises an end segment and an intermediate segment that connects said end segment to said widened part, wherein said end segment and said intermediate segment are oriented to form an obtuse angle therebetween such that an axis of said injection end of said pipette is not in along a continuation of an axis of said syringe.

17. The apparatus of claim 13, wherein said pipette comprises a tubular profile that defines, at a center thereof, a central conduit through which root canal irrigation solution is injected.

18. The apparatus of claim 13, wherein said tubular pipette extends from an injection end thereof to an inside of said connection sleeve at least as far as an end edge.

19. The apparatus of claim 13, wherein said pipette is conical, wherein said pipette terminates in a point and through an injection orifice of small diameter, thereby promoting a substantial injection pressure.

20. The apparatus of claim 18, wherein said end edge comprises two lateral diametric connection projections that are configured to permit connection of said sleeve to said syringe.

21. The apparatus of claim 13, wherein said pipette and said sleeve are made of plastic.

22. The apparatus of claim 21, wherein said pipette is a flexible pipetted made of polyvinyl chloride.

23. The apparatus of claim 13, wherein said sleeve is made of a first material and said pipetted is made of a second material, wherein said first material is more rigid than said second material.

24. The apparatus of claim said claim 13, wherein said sleeve comprises nylon.

25. The apparatus of claim 20, wherein said connection comprises a Luer lock connection.
